(19) United States
(12) Patent Application Publication
(10) Pub. No.: US 2022/0237660 A1
(43) Pub. Date: Jul. 28, 2022

(54) SYSTEMS AND METHODS FOR TARGETED ADVERTISING USING A CUSTOMER MOBILE COMPUTER DEVICE OR A KIOSK

(71) Applicant: Baüne Ecosystem Inc.

(72) Inventor: Aurélien Balondona, Edmonton (CA)

(21) Appl. No.: 17/584,737

(22) Filed: Jan. 26, 2022

Related U.S. Application Data
(60) Provisional application No. 63/142,388, filed on Jan. 27, 2021.

(51) Int. Cl. G06Q 30/02; G06Q 50/00

(52) U.S. Cl. CPC G06Q 30/0269; G06Q 50/01; G06Q 30/0261; G06Q 30/0276

(57) ABSTRACT

Computer-implemented systems, methods, and program products are provided for targeted advertising, which advertising may be delivered to either a customer mobile computer with an electronic display screen, or to a kiosk with an electronic display screen, or to both of them. The targeting of the advertisement to the customer may be based on one or a combination of the customer's demographic information provided by the customer, online social media content posted by the customer, and biometric information derived from digital image(s) of the customer acquired by digital cameras at the kiosk. Feedback content may be transmitted to a customer computer based on gaze information of the customer in respect to an advertising graphic displayed on the electronic display screen of the kiosk.

### CROSS-REFERENCE TO RELATED APPLICATIONS

This application claims priority to U.S. Provisional Patent Application No. 63/142,388, filed Jan. 27, 2021, which is incorporated by reference herein in its entirety.

### FIELD OF THE DISCLOSURE

Embodiments of the present disclosure generally relates to computer-implemented systems, methods, and program products for targeted advertising.

### BACKGROUND

Targeted advertising involves directing advertising toward a customer having certain attributes, in order to improve the effectiveness of the advertising, and reduce costs of the advertising for the advertiser. The prior art includes examples of targeted advertising using a kiosk. Examples are disclosed by Redmond et al. (U.S. Patent Application Publication No. US 2004/0133466 A1; Jul. 8, 2004), Heath (U.S. Pat. No. 8,138,930 B1; Mar. 20, 2012), Blaze et al. (U.S. Patent Application Publication No. US 2012/0323650 A1; Dec. 20, 2012), Chang (U.S. Patent Application Publication No. US 2015/0179015 A1; Jun. 25, 2015), and Schwarzli et al. (Canadian Patent Application No. CA 2891443 A1; Jul. 16, 2015). Notwithstanding, there remains a need for improvements in the art of targeted advertising.

### SUMMARY

Computer-implemented systems, methods, and program products are provided for targeted advertising, which advertising may be delivered to either a customer mobile computer with an electronic display screen, or to a kiosk with an electronic display screen, or to both of them. The targeting of an advertisement to the customer may be based on one or a combination of the customer's demographic information provided by the customer, online social media content posted by the customer, and biometric information derived from digital image(s) of the customer acquired by digital camera(s) at the kiosk. Feedback content may be transmitted to the customer mobile computer based on eye gaze information of the customer in respect to an advertising graphic displayed on the electronic display screen of the kiosk. Embodiments of the computer-implemented systems, methods, and program products are described in this specification and shown in the appended drawings.

In a first aspect, there is provided a computer-implemented method for delivering an advertising graphic to an electronic display screen viewable by a customer. The method comprises the steps of: (a) receiving a handle of the customer for a social media platform; (b) determining a matching score based on comparing predefined criteria for targeting the advertising graphic with online social media content posted in association with the handle; and (c) conditional on determining to target the advertising graphic to the customer, transmitting, to the electronic display screen, data for displaying the advertising graphic on the electronic display screen.

In embodiments, the predefined criteria comprises a metadata hashtag, a keyword and/or a second handle for the social media platform, and the online social media content comprises text content. In embodiments, the predefined criteria comprises a location, and the online social media content comprises location metadata.

In embodiments, the method comprises the step of receiving customer-defined demographic information of the customer, and the step of determining the matching score is further based on comparing the predefined criteria with the customer-defined demographic information.

In embodiments, the electronic display screen is part of a customer mobile computer. In embodiments, the electronic display screen is part of a kiosk.

In a second aspect, there is provided a system for delivering an advertising graphic to an electronic display screen viewable by a customer. The system comprises a processor, and a memory operatively connected to the processor. The memory comprises a non-transitory computer readable medium storing instructions, that when executed by the processor, cause the processor to implement an embodiment of the method of the first aspect described above. In embodiments, the system comprises a kiosk and the electronic display screen attached to the kiosk.

In a third aspect, there is provided a computer-implemented method for delivering an advertising graphic to an electronic display screen of a customer mobile computer, using an Internet wireless access point (WAP). The method comprising the steps of: (a) receiving location data indicative of a location of the customer mobile computer; (b) determining whether the customer mobile computer is within a predefined boundary that contains the Internet WAP, based on the location data; (c) conditional on determining that the customer mobile computer is within the predefined boundary, transmitting to the customer mobile computer, data for displaying the advertising graphic on the electronic display screen; and (d) conditional on the advertising graphic having been displayed on the electronic display screen, granting the customer mobile computer access to the Internet WAP.

In a fourth aspect, there is provided a system for delivering an advertising graphic to an electronic display screen of a customer mobile computer, the system comprises a processor; an Internet wireless access point (WAP), wherein the processor is operatively connected to the Internet WAP to configure access of the customer mobile computer to the Internet WAP; and a memory operatively connected to the processor. The memory comprises a non-transitory computer readable medium storing instructions, that when executed by the processor, cause the processor to implement a method of the third aspect described above.

In a fifth aspect, there is provided a computer-implemented method for delivering an advertising graphic to an electronic display screen viewable by a customer. The method comprises the steps of: (a) receiving at least one of customer-defined demographic information of the customer, or a handle of the customer for a social media platform; (b) analyzing a digital image of the customer to determine customer biometric information; (c) determining a matching score based on comparing predefined criteria for targeting the advertising graphic with the customer biometric information, and at least one of the customer-defined demographic information, or online social media content posted in association with the handle; (d) determining whether to target the advertising graphic to the customer based on the matching score; and (e) conditional on determining to target the advertising graphic to the customer, transmitting, to the electronic display screen, data for displaying the advertising graphic on the electronic display screen. In embodiments, the digital image is a thermographic digital image. In embodiments, the electronic display screen is part of a kiosk, and the digital image is acquired using a digital camera attached to the kiosk.

In a sixth aspect, there is provided a system for delivering an advertising graphic to a customer. The system comprises: a processor; an electronic display screen; a digital camera, wherein the processor is operatively connected to the digital camera to access digital images acquired by the digital camera; and a memory operatively connected to the processor. The memory comprises a non-transitory computer readable medium storing instructions, that when executed by the processor, cause the processor to implement an embodiment of the method of the fifth aspect described above. In embodiments, the system comprises a kiosk to which the electronic display screen and the digital camera are attached.

In a seventh aspect, there is provided a computer-implemented method for delivering feedback content to a customer mobile computer of a customer exposed to an advertising graphic. The method comprises the steps of: (a) analyzing a digital image of the customer to determine eye gaze information of the customer in relation to the advertising graphic; (b) determining whether to target the feedback content to the customer mobile computer, based on the eye gaze information; and (c) conditional on determining to target the feedback content to the customer mobile computer, transmitting, to the customer computer, data for displaying the feedback content on an electronic display screen of the customer computer. In embodiments, the feedback content comprises a share link for distributing the feedback content as a text message, email message, or online social media content. In embodiments, the advertising graphic is displayed on a kiosk, and the digital image of the customer is acquired using a digital camera attached to the kiosk.

In a seventh aspect, there is provided a system for delivering feedback content to a customer computer of a customer exposed to an advertising graphic. The system comprises: a processor; a digital camera, wherein the processor is operatively connected to the digital camera to access digital images acquired by the digital camera; and a memory operatively connected to the processor. The memory comprises a non-transitory computer readable medium storing instructions, that when executed by the processor, cause the processor to implement an embodiment of the method of the seventh aspect described above. In embodiments, the system further comprises a kiosk that displays the advertising graphic, and to which the digital camera is attached.

### BRIEF DESCRIPTION OF THE DRAWINGS

In the drawings, which form part of the specification, like elements may be assigned like reference numerals. The drawings are not necessarily to scale, with the emphasis instead placed upon the principles of the present disclosure. Additionally, each of the embodiments depicted are but one of a number of possible arrangements utilizing the fundamental concepts of the present disclosure.

FIG. 1 shows a schematic depiction of an embodiment of a system for targeted advertising in relation to a customer, a customer mobile computer, and online social media content.

FIG. 2 shows an embodiment of a kiosk of the system of FIG. 1.

FIG. 3 shows a functional block diagram of an embodiment of the system of FIG. 1, in relation to online social media content.

FIG. 4 shows a flow chart of a first embodiment of a method for targeted advertising, which may be implemented by the system of FIG. 1.

FIG. 5 shows an embodiment of a customer mobile computer displaying an interface of a webpage or an application for a customer to subscribe to an advertising service.

FIG. 6 shows an embodiment of a customer mobile computer displaying a webpage of a social media platform with online social media content posted by the customer.

FIG. 7 shows a table illustrating an embodiment of an association between an advertising graphic, and predefined criteria for targeting the advertising graphic.

FIG. 8 shows a flow chart of a second embodiment of a method for targeted advertising which may be implemented by the system of FIG. 1.

FIGS. 9A and 9B, collectively, show a flow chart of a third embodiment of a method for targeted advertising which may be implemented by the system of FIG. 1.

### DETAILED DESCRIPTION

The disclosure relates to computer-implemented systems, methods, and program products for targeted advertising. Any term or expression not expressly defined herein shall have its commonly accepted definition understood by a person skilled in the art.

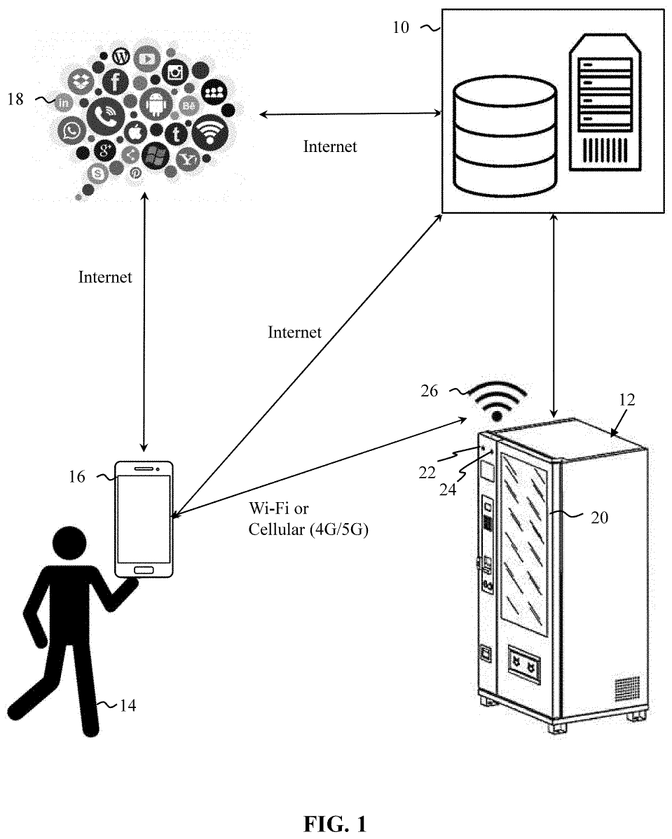

FIG. 1 shows a schematic depiction of an embodiment of a system for targeted advertising including a system computer (10) and a kiosk (12). The system is shown in relation to a customer (14) to whom advertising is to be targeted, a customer mobile computer (16) used by the customer (14), and online social media content (18) posted by the customer (14). The double-headed arrow lines, between the elements show operative data communication paths. In general, these data communication paths may be implemented by wired and/or wireless communication paths. The data communication paths between the customer mobile computer (16), online social media content (18), and the system computer (10) may include a communications network comprising the Internet. The data communication path between the system computer (10) and the kiosk (12) may or may not include the Internet. The data communication path between the customer mobile computer (16) and a wireless Internet access point of the kiosk (12) may be established in accordance with wireless communication protocols such as Wi-Fi and Bluetooth™.

The customer mobile computer (16) may be any portable computing device used by the customer, which device has an electronic display screen for displaying an advertising graphic, and a communication means for transmitting and receiving data wirelessly. For some embodiments, it will also be required that the customer mobile computer (16) have input means for the customer to enter information (e.g., a touchscreen and/or physical keyboard), and means for determining the location of the customer mobile computer (16) (e.g., a GPS receiver and processor). As a non-limiting example, the customer mobile computer (16) may be a handheld tablet computer or smartphone operating on the Android™ or iOS™ operating system, and capable of wireless data transmission and reception via one or more of cellular (e.g., 4G and/or 5G standard), Wi-Fi, and Bluetooth™ protocols. As another non-limiting example, the customer mobile computer (16) may be a computer installed in a vehicle (not shown).

“Online social media content”, as used herein, refers to content (e.g., text, digital images, digital video, and digital audio, or a combination thereof) posted by a user of a social media platform on the Internet in association with a “handle” (i.e., an identifier of the user of the social media platform that publicly names the user that posted the content), which content is accessible via the Internet. For clarity, “online social media content”, does not include content in an email message, or content entered into an Internet search engine. Non-limiting examples of social media platforms include Facebook™, Twitter™, LinkedIn™, Instagram™ Pinterest™, YouTube™, Tumblr™, Snapchat™, WordPress™, and the like. As known in the art, a handle may be used as part of a web address for a webpage hosted by a social media platform, or may be used to identify the user that posted the online social media content (18). As a non-limiting example, if a user of the Twitter™ social media platform has the handle is ‘Customer_1’, then the Twitter™ platform may host a webpage at the address <twitter.com/username>, and content posted by the user may be displayed in association with the handle ‘@Customer_1’.

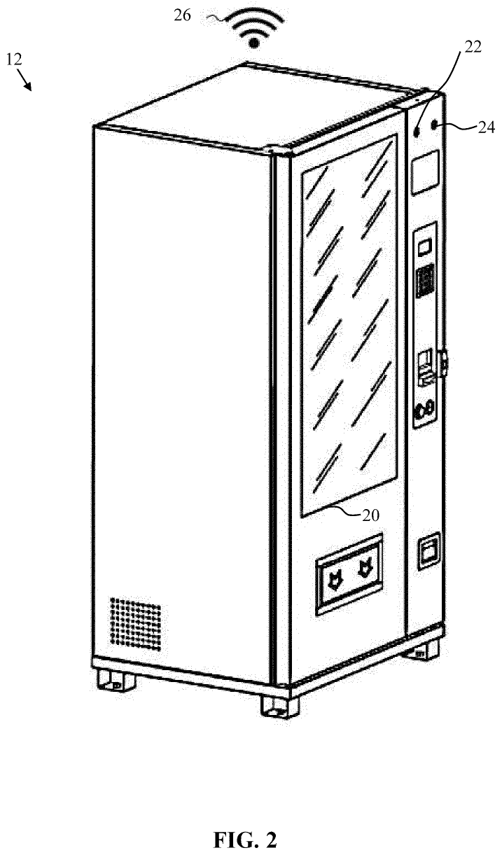

FIG. 2 shows an embodiment of a kiosk (12) forming part of the system of FIG. 1. In use, the kiosk (12) may be located in a public environment, such as a sidewalk, a shopping center or store, or a transit terminal such as an airport, train station, bus station. As used herein, a kiosk is any designated location, structure or device intended to vend and/or advertise merchandise or services.

In the embodiment shown in FIG. 2, the kiosk (12) includes a vending machine that includes means for storing a product (e.g., shelves, racks, compartments), means for accepting payment for the product (e.g., an interface for receiving cash, coins, cards or electronic payment information), and means for dispensing a product to the customer (e.g., a device that conveys the product to an access door, or a device that unlocks a door to allow the customer to access the product). In other embodiments, the kiosk (12) may not include a vending machine.

The kiosk (12) includes an electronic display screen (20) for displaying an advertising graphic. Non-limiting examples of suitable electronic display screens (20) include a liquid crystal display (LCD), a light-emitting diode (LED) display, a plasma display or other flat-panel display screens.

The kiosk (12) includes at least one digital camera (22, 24) for capturing a digital image of the customer, either as a still image or as a video. In embodiments, the at least one digital camera may include a conventional camera (22) having a sensor that detects visible light to form the digital image. Alternatively or additionally, the at least one digital camera may include a thermographic camera (24) having a sensor that detects infrared radiation to form the digital image, and which allows the temperature of objects in the digital image to be determined.

The kiosk (12) also includes an Internet wireless access point (WAP) (26). “Internet wireless access point” or “Internet WAP” (26) as used herein refers to hardware, and associated software or firmware, for establishing a wireless data connection between the customer mobile computer (16) and the Internet. As a non-limiting example, the Internet WAP (26) may a wireless router and an operatively connected Wi-Fi and/or cellular modem, which is connected to the Internet.

The system computer (10) is a computer device that is distinct from the customer mobile computer (16). In FIG. 1, the system computer (10) is shown as physically separate from the kiosk (12). However, it will be understood that in embodiments, part or all of the system computer (10) may be physically integrated in whole or in part with the kiosk (12). For example, some components of the system computer (10) may be physically contained in a housing of the kiosk (12), while other components of the system computer (10) may be located remotely from the kiosk (12), and implemented as part of a distributed computing or cloud computing infrastructure.

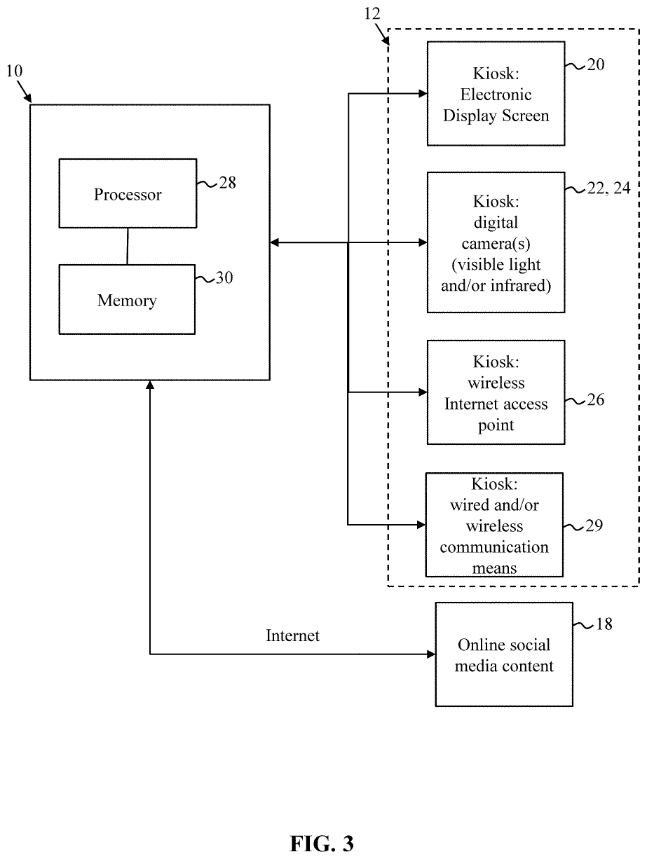

FIG. 3 shows a functional block diagram of the system computer (10) in relation to the electronic display screen (20), digital camera(s), and Internet WAP (26) of the kiosk (12), and in relation to the online social media content (18).

The system computer (10) includes a processor (28). “Processor”, as used herein, refers to one or more electronic devices that is/are capable of reading and executing instructions stored on a memory to perform operations on data, which may be stored on a memory or provided in a data signal. Non-limiting examples of processors include devices referred to as microprocessors, microcontrollers, central processing units (CPU), and digital signal processors. The term “processor” includes a plurality of physically discrete, operatively connected devices despite use of the term in the singular.

The system computer (10) includes a memory (30) operatively connected to the processor (28). “Memory”, as used herein, refers to a non-transitory tangible medium for storing information in a format readable by a processor (28), and/or instructions readable by a processor (28) to implement an algorithm. Non-limiting types of memory include solid-state, optical, and magnetic computer readable media. The term “memory” includes a plurality of physically discrete, operatively connected devices despite use of the term in the singular. Instructions stored by a memory may be based on a plurality of programming languages known in the art, with non-limiting examples including the C, C++, Python, MATLAB, and Java programming languages. The memory (30) stores instructions executable by the processor (28) to implement one or more embodiments of the method as described below. The memory (30) storing such instructions may be considered to be a computer program product.

The system computer (10) is operatively connected to the electronic display screen (20) of the kiosk (12) to output a data for an advertising graphic to the electronic display screen (20). Such operative connection may be implemented by a wired and/or wireless data output interface as known in the art, such as a High-Definition Multimedia Interface (HDMI) data connection, or a wireless data transceiver.

The system computer (10) is operatively connected to the digital camera(s) (22, 24) of the kiosk (12) to access or receive the digital image(s) captured by the digital camera(s) (22, 24). Such operative connection may be implemented by a wired and/or wireless data input interface as known in the art, such as a Universal Serial Bus (USB) data connection, or a wireless data transceiver.

The system computer (10) is operatively connected to the Internet WAP (26) of the kiosk (12) to control processes for “sign-in” and “sign-off” of the customer mobile computer (16) to and from the Internet WAP (26), and thereby configure access to the Internet WAP (26).

The system computer (10) is operatively connected via the Internet to access the online social media content (18).

As noted, components of the system computer (10) may be located remotely from the kiosk (12). Accordingly, embodiments of the kiosk (12) may include wired and/or wireless communications means (29) (e.g., an Internet modem, or cellular modem) for transceiving data with system computer (10) via communications network. This includes receiving data for displaying an advertising graphic on the electronic display screen (20) of the kiosk (12), and for allowing the system computer (10) to access or receive digital images acquired by the digital cameras (22, 24) of the kiosk (12).

The system as discussed above with respect to different embodiments, may be used to implement methods of the present disclosure, as will be described below. In particular, it will be understood that such methods are implemented by the processor (28) of the system computer (10), reading and executing instructions stored on the memory (30) and controlling the operatively connected components of the kiosk (12) as needed.

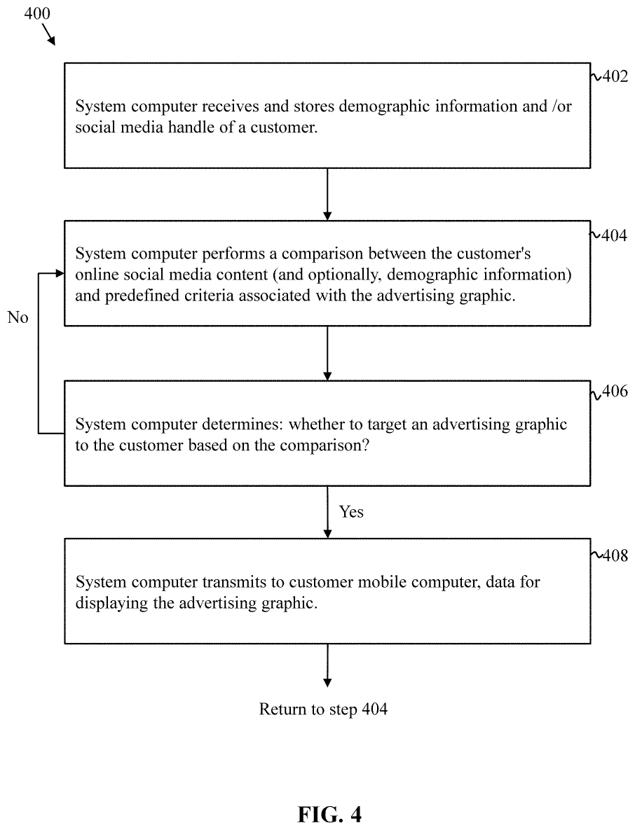

FIG. 4 shows a flow chart of steps of a first embodiment of a method (400).

At step (402), the system computer (10) receives and stores customer information, including customer demographic information and/or one or more customer social media handle(s) of the customer.

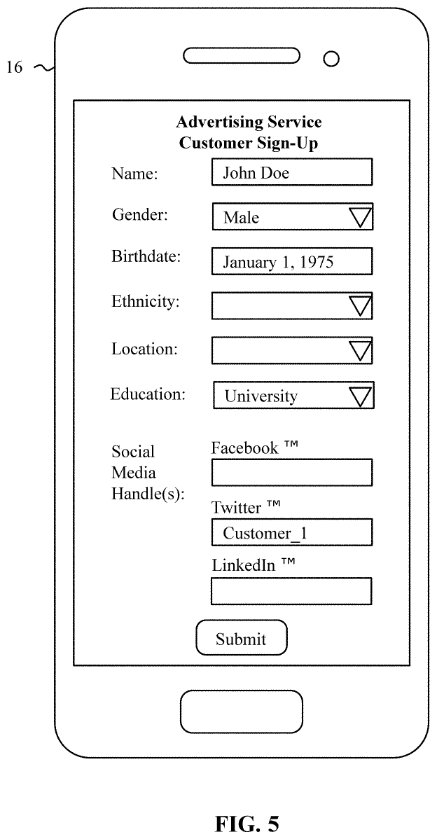

This step may be implemented by any method. As an illustrative example, this step may be implemented using an interface of a webpage or dedicated application on the customer mobile computer (16), as shown in FIG. 5. The interface includes data entry fields (e.g., text boxes, selectable drop-down boxes, and the like) that allow the customer to enter the customer's demographic information and social media handles. Non-limiting examples of the customer's demographic information include gender, birthdate, ethnicity, residence location, income level, occupation, education level, marital status, and family status. As non-limiting illustrative example, a customer may enter demographic information indicating that the customer is male, a birthday of Jan. 1, 1975, a University-level education level, and uses a social media platform with the handle ‘Customer_1’. After the customer enters this information, the customer selects the ‘Submit’ button, causing this information to be transmitted to the system computer (10), and stored by the system computer (10). Alternatively, the customer information may be stored on the customer mobile computer (16) from a previous interaction with a kiosk or a website associated with the vendor or kiosk operator, and communicated to the system computer when the customer mobile computer connects to the kiosk.

In this example, the customer has used the customer mobile computer (16) or another computer to post online social media content (18) in association with a handle, on the social media platform, prior to subsequent step (404).

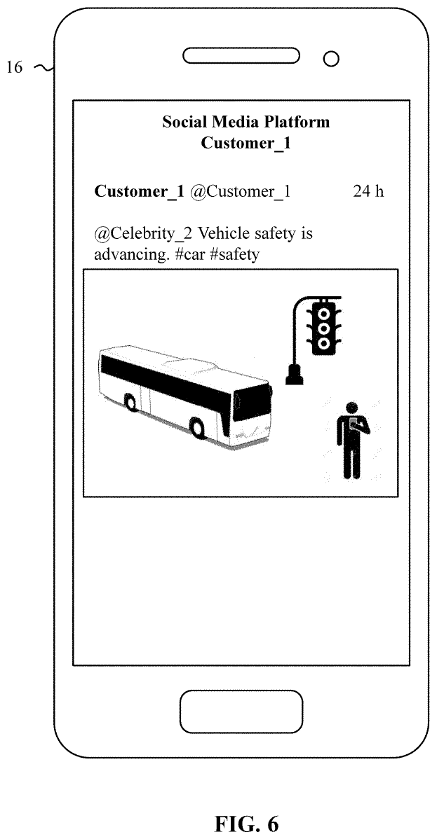

Continuing the illustrative example, suppose that the customer posts, in association with the handle “@Customer_1”, the online social media content (18) as shown in FIG. 6, which includes the text content “@Celebrity 2 Vehicle safety is advancing. #car #safety”, and a photograph of a bus, pedestrian, and traffic light. The content “@Celebrity_2” is a handle of another user of the social media platform, and is in the form of a clickable link addressed to a webpage that posts online social content of the other user. The social media platform may distribute this content to other computer devices in a variety of ways. As non-limiting examples, the social media platform may host a webpage for the account ‘Customer_1’ or other account that follow ‘Customer_1’ that includes this content, host a webpage for queries of the metadata tags ‘#car’ and ‘#safety’ that include this content, and/or send notifications of this content to the “feed” of other account that subscribe to content posted by the account ‘Customer_1’. The present disclosure is not limited by the particular manner in which the online social media content (18) is available via the Internet.

At step (404), the computer system performs a comparison between the customer's online social media content (18) (and optionally the customer's demographic information) and predefined criteria for targeting an advertising graphic.

“Advertising graphic”, as used herein, refers to any human-readable content, such as one or a combination of text, a digital image, and digital video, for promoting a product, service, or cause, which can be displayed on the display screen of the customer mobile computer (16) and/or the electronic display screen of the kiosk (12).

“Predefined criteria”, as used herein, refers to attributes of the customer (14) or the online social media content (18) posted by the customer (14), that are used to determine whether or not to target an advertising graphic to the customer (14). The predefined criteria may be defined by a sponsor of an advertising graphic, or an administrator of the system, and stored by the system computer (10). The present disclosure is not limited by any number of advertising graphics, or the types or number of predefined criteria associated with each advertising graphic.

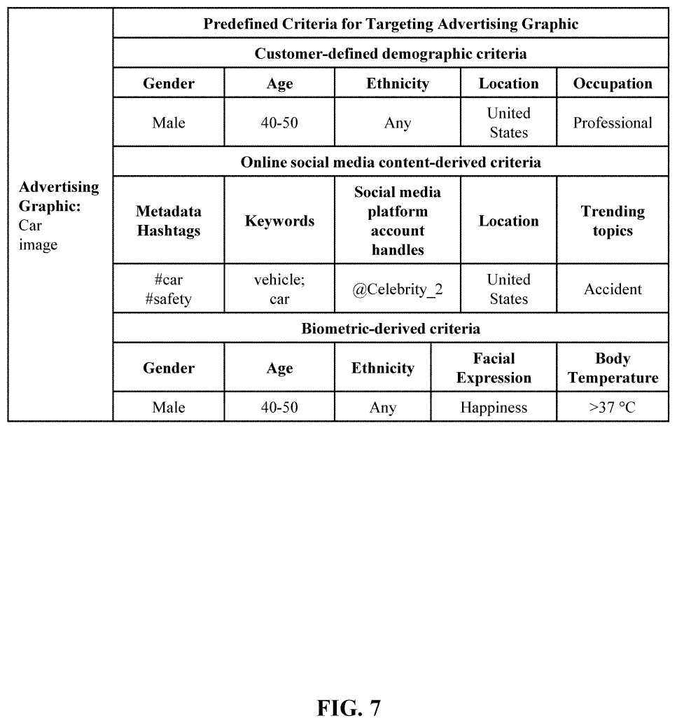

Continuing with the illustrative example, suppose that the system computer (10) stores a set of predefined criteria, as shown in the table of FIG. 7, which are associated with an advertising graphic for a car. The first set of predefined criteria, ‘Customer-defined demographic criteria’ relate to the demographic information supplied by the customer, and stored by the system computer (10), such as in step (402). In this example, the advertising graphic is to be targeted to customers that are male, between the ages of 40 to 50 years old, of any ethnicity, located in the United States, and of professional occupations. The system computer (10) may store a different set of predefined criteria, which are associated with different advertising graphics. As a non-limiting example, the system computer (10) may store a set of predefined criteria for a different advertising graphic for the same car, which is targeted to customers that are female, between the ages of 60 to 70 years old, and retired.

The second set of predefined criteria, ‘Online social media content-derived criteria’, relate to attributes of the online social media content (18). Such predefined criteria may include metadata hashtags, keywords in text content, a social media handle of a user of the social media platform other than the customer (e.g., the account name of a celebrity associated with an advertisement campaign shown in FIG. 7 as “@Celebrity_2”), locations, and trending topics.

The third set of criteria, ‘Biometric-derived criteria’ relate to attributes of the customer that are determined from digital images of the customer acquired by the digital cameras (22, 24) of the kiosk (12). This set of predefined criteria is not used in this first embodiment of the method, but may be used in other embodiments of the method, such as described below.

Continuing with the illustrative example, performing the comparison may be carried out as follows. Having stored the customer's demographic information, the system computer (10) may execute algorithms to match the stored demographic information of the customer with the predefined criteria in the category of ‘Customer-defined demographic information’.

Having stored the handle ‘Customer_1’, the system computer (10) may access online social media content (18) associated with this account. As non-limiting examples, the computer system may periodically query the social media platform's webpage for the account ‘Customer_1’, or be logged into its own account that subscribes to a feed of online social media content (18) posted by the account ‘Customer_1’. The present disclosure is not limited by the manner by which the system computer (10) accesses the online social media content (18) posted by the account ‘Customer_1’. Having accessed this online social media content (18), the system computer (10) may execute algorithms to search for and/or extract text strings and/or metadata (e.g., hashtag labels, and location metadata such as GPS coordinates indicating a location where a digital image in the social media content was taken, or where the customer was when the social media content was posted) in the online social media content (18) that match the predefined criteria in the category of ‘Online social media content (18)-derived criteria.’ For the examples of FIGS. 6 and 7, the system computer (10) would determine matches for the metadata hashtags “#car” and “#safety”, the keyword “vehicle”, and the social media handle “@Celebrity_2” in the online social media content (18).

At step (406), the system computer (10) determines whether to target the advertising graphic to the customer based on the comparison performed in step (404). “Based on”, as used in this context, means that the determination depends on the results of the comparison with or without other factors, or a metric derived from the comparison with or without other factors.

Continuing with the illustrative example, the system computer (10) may compute a matching score based on the number of matches between the predefined criteria and the customer's demographic information, and online social media content (18) attributes. The system computer (10) may apply different weightings to matches for different predefined criteria. The system computer (10) may apply rules that require certain predefined criteria to be matched, or for the matching score to exceed a predefined minimum value, in order to determine to target the advertising graphic. The system computer (10) may perform step (404) in respect to the different predefined criteria for different advertising graphics, and determine that the customer (14) is to be targeted for the advertising graphic associated with the highest matching score. The present disclosure is not limited by any particular logic by which the determination is based on the comparison.

If the system computer (10) determines to not target the advertising graphic to the customer (14), then the method returns to step (404), and the method continues.

Conversely, if the system computer (10) determines to target the advertising graphic to the customer, then at step (408), the system computer (10) transmits, to the customer mobile computer (16), data for displaying the advertising graphic on the display screen of the customer mobile computer (16).

Continuing with the illustrative example, the system computer (10) may transmit, to the customer mobile computer (16), a digital image file, a digital video file, or a data stream for a digital video for displaying the advertising graphic for the car. As non-limiting examples, the system computer (10) may transmit a “push notification” to the customer mobile computer (16), which when accessed by the customer, causes the advertising graphic to be displayed in a webpage of a web browser, or an interface of a dedicated application, which may be the same as or different than from application that the customer (402) used to subscribe to the advertising service.

At the conclusion of step (408), the method returns to step (404), and continues.

It will be appreciated that the method (400) may be performed simultaneously or sequentially in respect to a plurality of different social media accounts for a single customer, and simultaneously in respect to a plurality of different customers.

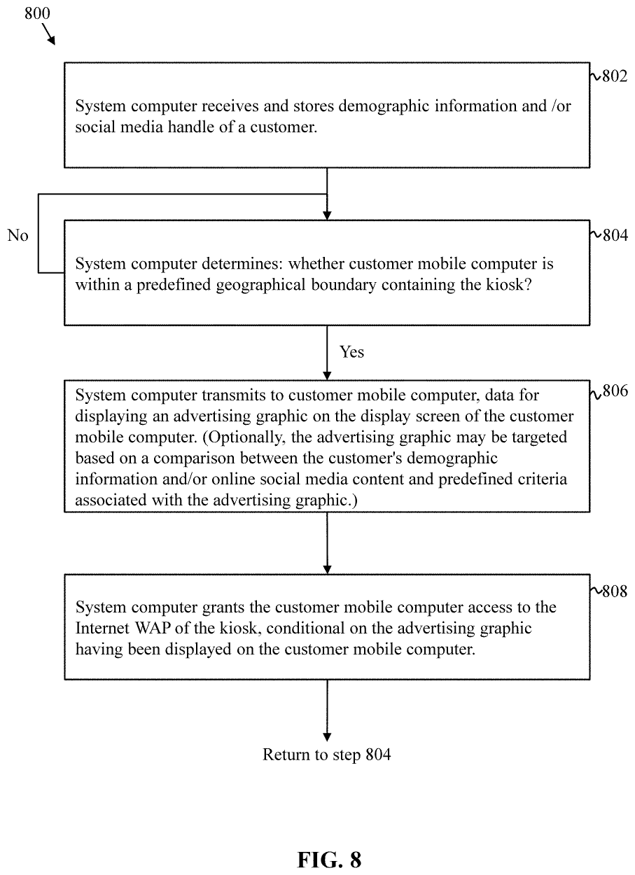

FIG. 8 shows a flow chart of steps of a second embodiment of a method of the present disclosure.

Step (802) is analogous to step (402) of the first embodiment of the method as described above.

At step (804), the system computer (10) determines whether the customer mobile computer (16) is within a predefined geographic boundary containing the kiosk (12).

As an illustrative example, the administrator of the system, knowing the geographic location of the kiosk (12), may predefine a geographic boundary surrounding the kiosk (12). For example, the boundary may be a circular region with the kiosk (12) at its center and a radius selected to approximate the signal range of Internet WAP (26) of the kiosk (12). A dedicated application (which may be the same as or different than from application that the customer (14) used to subscribe to the advertising service) utilizes a GPS receiver and processor of the customer mobile computer (16) to periodically determine the location coordinates of the customer mobile computer (16). The dedicated application causes the customer mobile computer (16) to periodically transmit the location coordinates to the system computer (10). The system computer (10) performs geometric computations to determine whether the location coordinates are within the predefined boundary. The present disclosure is not limited by any particular method of determining the location of the customer mobile computer (16). The determination may be made in accordance with geo-fencing techniques, which are known to persons skilled in the art. As examples, instead of relying on GPS-based location coordinates, the location of the customer mobile computer (16) may be determined by a dedicated application running on the customer mobile computer (16) device that performs multi-lateration computations of cellular signals, or Wi-Fi signals, which may be transmitted by transmitters associated with the kiosk (12), or installed in the vicinity of the kiosk (12).

If the system computer (10) determines that the customer mobile computer (16) is not within the predefined geographic boundary containing the kiosk (12), then the method iterates step (804).

Conversely, if the system computer (10) determines that the customer mobile computer (16) is within the predefined geographic boundary containing the kiosk (12), then at step (806), the system computer (10) transmits, to the customer mobile computer (16), data for displaying the advertising graphic on the display screen of the customer mobile computer (16). This step is analogous to step (408) of the first embodiment of the method, as described above. Optionally, the advertising graphic that is transmitted to the customer mobile computer (16) may be targeted based on a comparison between the customer's demographic information and/or online social media content (18) and predefined criteria associated with the advertising graphic, in accordance with steps analogous to steps (404) and (406), of the first embodiment of the method described above.

At step (808), the system computer (10) grants the customer mobile computer (16) access to the Internet WAP (26) of the kiosk (12), conditional on the advertising graphic having been displayed on the customer mobile computer (16). Thus, the customer computer device (16) may access the Internet using the Internet WAP (26) of the kiosk (12) as a “hotspot” or “hub”.

As a non-limiting example, after the advertising graphic has been displayed on the customer mobile computer (16), a button may become enabled on the interface of a webpage or a dedicated application. The customer (14) may select the button to “sign in” the customer mobile computer (16) to the Internet WAP (26) of the kiosk (12), to access the Internet. The selection of the “sign in” button causes the customer mobile computer (16) to transmit, to the system computer (10), a request to access the Internet WAP (26) of the kiosk (12). In response to receiving the request, the system computer (10) can configure the Internet WAP (26) to permit the customer mobile computer (10) to access the Internet WAP (26) of the kiosk (12).

As another non-limiting example, before step (806), the customer mobile computer (16) may generate an interface on a webpage or a dedicated application for the user (14) to request access to the Internet WAP (26) of the kiosk (12). In response to this request, the system computer (10) carries out step (806) causing the advertising graphic to be displayed on the electronic display screen of the customer mobile device (16). Automatically thereafter, the system computer (10) grants the customer mobile computer (16) access to the Internet WAP (26) of the kiosk (12).

At the conclusion of step (808), the method returns to step (804), and continues.

It will be appreciated that the method (800) may be performed simultaneously in respect to a plurality of different customer mobile computers (16).

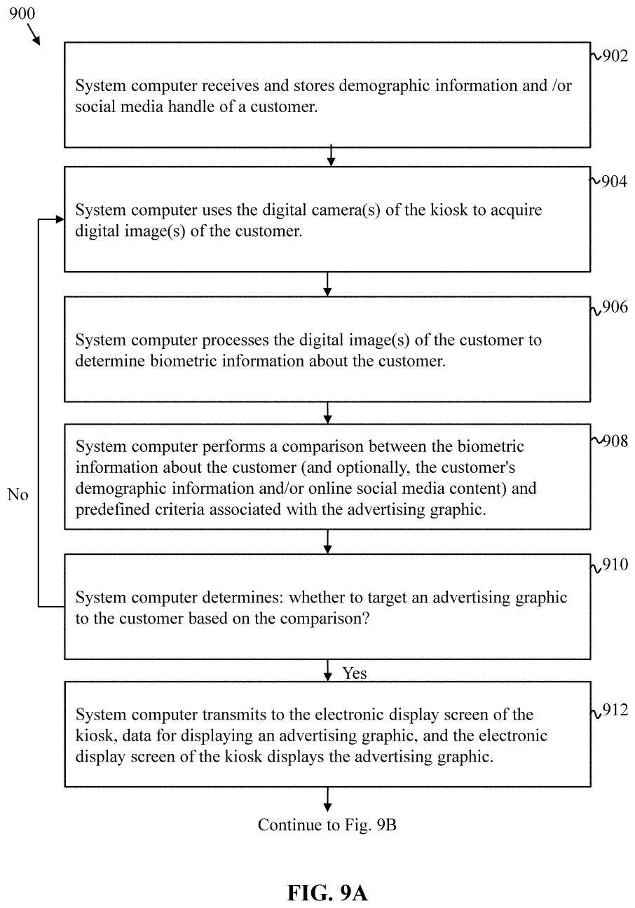

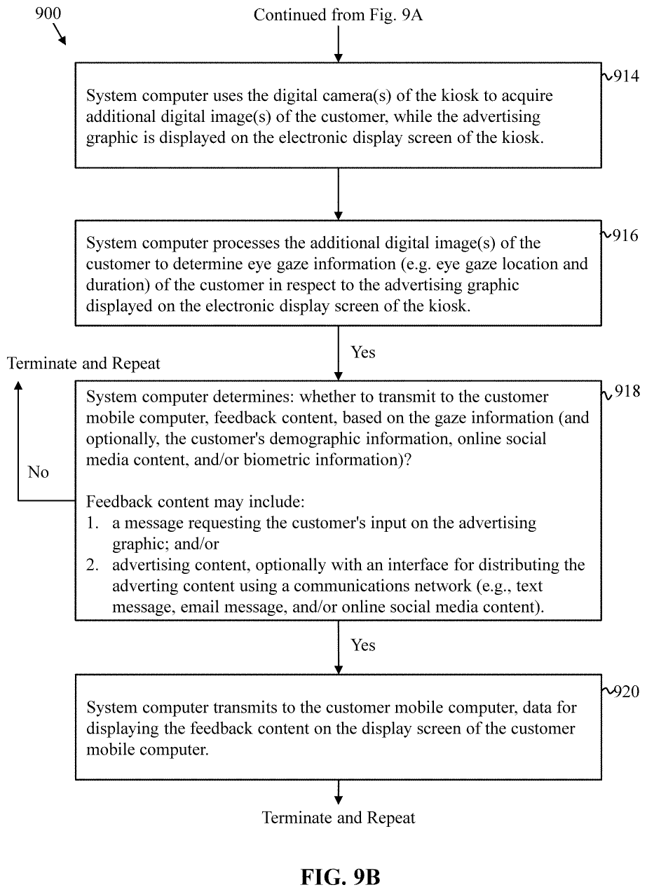

FIGS. 9A and 9B show a flow chart of steps of a third embodiment of a method of the present disclosure.

Step (902) is analogous to step (402) of the first embodiment of the method described above.

At step (904), the system computer (10) uses the digital camera(s) (22, 24) of the kiosk (12) to acquire digital image(s) of the customer.

As a non-limiting illustrative example, the system computer (10) may activate the digital camera(s) to acquire the digital images(s) of the customer. This activation may be in response to a variety of different events indicating that the customer (14) is in physical proximity to the kiosk (12). As a non-limiting example, the activation may be in response to detection of an interaction with a user interface of the kiosk. For example, the customer (14) may physically interact with the kiosk (12), such as by pressing buttons, a touch screen interface to select a product to purchase, or an payment interface (e.g., buttons, a contactless or “tap” credit card payment interface, or a bill or coin deposit interface) in the case where the kiosk (12) includes a vending machine. As another non-limiting example, the activation may be in response to a motion detector of the kiosk (12) detecting the motion of the customer (14). As another non-limiting example, the activation may be in response to a determination that the customer mobile computer (16) device is within a predefined geographical boundary containing the kiosk (12). This determination may be made in accordance with steps analogous to step (804) of the second embodiment of the method described above, but with the geographic boundary being defined by a suitable position for viewing an advertising graphic on the electronic display screen (20) of the kiosk (12).

At step (906), the system computer (10) processes the digital image(s) of the customer to determine biometric information about the customer. “Biometric information”, as used herein, refers to information relating to a physical characteristic and/or behavioral characteristic of the customer. As non-limiting examples, the characteristic may be an age and/or gender of the customer based on recognition of characteristics such as height and hair color of the customer in the digital image, an ethnicity of the customer based on recognition of the customer's appearance, such as skin tone and hair color in the digital image, a mood or emotion of the customer based on recognition of a facial pattern of the customer in the digital image, or a body temperature of the customer based on analysis of a thermographic digital image. These determinations may be made in accordance with algorithms that employ pattern recognition, computer vision, machine learning, and/or artificial intelligence techniques, known to persons skilled in the art. The biometric information of the customer (14) determined in this step may be used to supplement and/or verify demographic information (if any) stored by the system computer (10) in step (902). In some embodiments, for privacy reasons, this step may be performed by components of the system computer (10) that are physically located at the kiosk (12), so as to avoid having to transmit digital image(s) of the customer to remote components of the system computer (10).

At step (910), the computer system (10) performs a comparison between the determined biometric information about the customer (14) (and optionally the customer's demographic information, and online social media content (18), as discussed below) and predefined criteria for targeting an advertising graphic. This step is analogous to step (404) of the first embodiment of the method, as described above, except that the biometric information is compared with the predefined criteria in the category of ‘Biometric-derived criteria’ in the example of FIG. 7 in order to determine the matching score.

Optionally, at step (910), the computer system (10) may also perform a comparison between the customer's demographic information, and/or online social media content (18) with the predefined criteria for targeting the advertising graphic to determine the matching score. As a non-limiting example, as described above, a dedicated application running on the customer mobile computer (16) may be configured to transmit location data, which may be used to control activation of the digital camera(s) of the kiosk. The dedicated application may also be configured to transmit an identifier that allows the system computer to identify the customer in question, so that the system computer can retrieve the relevant customer's customer information (i.e., demographic information and/or social media handles) as stored in step (402) in the first embodiment of the method described above, as opposed to customer information of a non-relevant customer that is not physically near the kiosk (12). Alternatively, the dedicated application may also be configured to transmit the customer information (i.e., demographic information) that may be stored locally on the customer mobile computer (16), or the customer's social media handle. In either case, the system computer can then compare the retrieved or transmitted customer information, and/or online social media content posted in association the social media handle, with the predetermined criteria associated with the advertising graphic, in a manner analogous to step (404) of the first embodiment of the method to determine the matching score.

At step (910), the system computer (10) determines whether to target an advertising graphic to the customer (14) based on the comparison performed in step (910). This step is analogous to step (406) of the first embodiment of the method, as described above.

As a non-limiting illustrative example, suppose that step (906) processes digital image(s) of the customer (14) to determine that the facial expressions of the customer (14) is indicative of the customer having an emotion or mood of “happiness”, as opposed to “sadness.” At step (908), the comparison indicates a match between this biometric information and the predefined criteria in the sub-category ‘Facial Expression’ of the category ‘Biometric-derived criteria’ in the table of FIG. 7. Based on this match, the system computer may determine to target the associated advertising graphic for the car to the customer (14), in preference to other advertising graphics that are considered less suitable or effective for a customer with an emotion or mood of “happiness”. As another non-limiting example, the ethnicity of the customer (14) as determined from the digital image(s) may be used to target an advertising image having text in a language that may be commonly used by customers of the determined ethnicity.

In embodiments described above, the determination to target the advertising graphic is based on the biometric information, in combination with online social media content posted by the customer, and/or demographic information of the customer. In such embodiments, it will be appreciated that the combined sources of information may provide a profile of the customer that is more comprehensive, and more nuanced, when the decision is made, in real time, on whether or not to target the advertising graphic to the customer, in comparison to relying solely on one of the sources of information.

The profile may also be more reliable to the extent it is based on the multiple sources of information. For example, in the event that the customer does not enter accurate customer-defined demographic criteria (e.g., age), the biometric information determined by processing of the digital image(s) of the customer may provide a secondary source of data that is accounted for in determining the matching score with the predefined criteria for targeting the advertising graphic. Conversely, to the extent that the biometric information determined by processing of the digital image(s) of the customer might not be reliable, the customer-defined demographic criteria and/or the online social media content may provide a secondary source of data that is accounted for in determining the matching score with the predefined criteria for targeting the advertising graphic.

If the system computer (10) determines to not target the advertising graphic to the customer (14), then the method returns to step (904), to acquire digital image(s) of another customer, or the method may terminate.

Conversely, if the system computer (10) determines to target the advertising graphic to the customer (14), then at step (912), the system computer (10) transmits, to the electronic display screen (20) of the kiosk (12), data for displaying the advertising graphic, and the electronic display screen (20) of the kiosk (12) displays the advertising graphic.

At step (914), the system computer (10) uses the digital camera(s) of the kiosk (12) to acquire additional digital image(s) of the customer, while the advertising graphic is displayed on the electronic display screen of the kiosk (12).

At step (916), the system computer (10) processes the additional digital image(s) of the customer to determine eye gaze information of an eye of the customer in respect to the advertising graphic displayed on the electronic display screen (20) of the kiosk (12). The eye gaze information may include a point-of-gaze (i.e., a location on the electronic display screen (20) of the kiosk (12), and hence a location on the advertising graphic), and may include a duration of the gaze in respect to the whole or portions of the electronic display screen (20). This determination may be performed in accordance with algorithms for eye-tracking and/or gaze direction-tracking that analyze eye position and eye movement in the frame of the additional digital image(s), as known in the art. In some embodiments, for privacy reasons, this step may be performed by components of the system computer (10) that are physically located at the kiosk (12), so as to avoid having to transmit the additional digital image(s) of the customer to remote components of the system computer (10).

As an alternative to steps (914) and (916), as described above, the kiosk (12) may be equipped with alternative means to determine gaze information of an eye of the customer in respect to the advertising graphic displayed on the electronic display screen (20) of the kiosk (12). Such means may include non-contact optical eye-tracking and/or gaze direction-tracking technologies that include a source of infrared light, and a video camera or optical sensor to detect reflections of the infrared light from the eye, or sensors that track movement of eye features such as retinal blood vessels. The present disclosure is not limited by a particular means for determining the gaze information of the eye of the customer in respect to the advertising graphic displayed on the electronic display screen of the kiosk (12).

At step (918), the system computer (10) determines whether to transmit feedback content to the customer mobile computer (16) or another computer used by the customer, which may or may not be mobile; the customer mobile computer (16) or such other computer is herein referred to as a “customer computer”. In embodiments, the feedback content may include a message requesting the customer's input on the advertising graphic that was displayed on the electronic display screen (20) of the kiosk (12) in step (916). For example, the message may include survey questions about the customer's opinion of the advertising graphic. In embodiments, the feedback content may include additional advertising content, such as an advertising message, or a second advertising graphic. The feedback content may include “share links” for sharing or commenting on the feedback content on a communications network. As non-limiting examples, “share links” may be provided to share the feedback content via a telephone text message (SMS or MMS), to share the feedback content via an email message or as online social media content (18), or to “like” or comment on the feedback content on a social media platform.

The determination in step (918) is based on the eye gaze information determined in step (916) (and optionally the customer's demographic information, online social media content (18), and biometric information). As a non-limiting example, the gaze information (e.g., the eye gaze location and duration) may be converted to a quantitative attention score, with a higher attention score being associated with eye gaze location directed at the advertising graphic, and longer eye gaze duration. If the gaze information indicates that the customer (14) was highly attentive to the advertising graphic displayed on the electronic display screen (20) of the kiosk (12), then this will translate into a higher attention score, and it may be inferred that the customer (14) was interested in the advertised product or service. To leverage this interest, if the attention score is above a certain predetermined level, then the determination may be made to transmit the feedback content, including advertising content, to “re-target” the customer (14) with additional advertising content. Alternatively, if the gaze information indicates that the customer (14) was highly inattentive to the advertising graphic displayed on the electronic display screen (20) of the kiosk (12), then this will translate to a lower attention score, it may be inferred that the customer (14) was disinterested in the advertised product or service. As such, if the attention score is below a certain predetermined level, then the determination may be made to not transmit the feedback content, in order to avoid additional advertising costs. Alternatively, the determination may be made to transmit the feedback content, including survey questions about the customer's opinion of the advertising graphic, in order to determine reasons for the customer's disinterest. The present disclosure is not limited by any particular logic by which this determination is based on the gaze information.

If the system computer (10) determines to not transmit to the customer mobile computer (16) or other customer computer, the feedback content, then the method may terminate and repeat.

Conversely, if the system computer (10) determines to transmit the feedback content to the customer mobile computer (16) or another customer computer, then at step (920), the system computer (10) transmits to the customer mobile computer (16) or other customer computer, data for displaying the feedback content on the display screen of the customer mobile computer (16) or other customer computer. The customer (14) may use “share links” in the feedback content to further distribute, “like” or “comment” on the feedback content, as described above, to the customer's contacts (e.g., friends, family, and followers on social media platforms).

As a non-limiting example, a dedicated application running on the customer mobile computer (16) or other customer computer may be configured to transmit location data, and an identifier (e.g., a social media handle) that allows the system computer to identify the customer in question. Based on this information, the system computer may be able to identify the customer in question, so that the system computer can retrieve the relevant customer's customer contact information (e.g., an email address, or a telephone number for the customer), or use the customer's social media handle for communication with the customer mobile computer (16). As non-limiting examples, the system computer (10) can transmit the feedback content to the customer mobile computer (16) as an email to the email address, as a text message to the telephone number, or a direct message (DM) or private message facility of the social media platform. Alternatively, the system computer (10) can transmit the feedback content to the customer computer (16) or other customer computer for display on the dedicated application running on the customer mobile computer (16) or other customer computer.

At the conclusion of step (918), the method may terminate and repeat.

Aspects of the present disclosure may be described with reference to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the present disclosure.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A computer-implemented method for delivering an advertising graphic to an electronic display screen viewable by a customer, the method comprising the steps of:
receiving a handle of the customer for a social media platform;
determining a matching score based on comparing predefined criteria for targeting the advertising graphic with online social media content posted in association with the handle;
determining whether to target the advertising graphic to the customer based on the matching score; and
conditional on determining to target the advertising graphic to the customer, transmitting, to the electronic display screen, data for displaying the advertising graphic on the electronic display screen.

2. The method of claim 1, wherein the predefined criteria comprises a metadata hashtag or a keyword, and the online social media content comprises text content.

3. The method of claim 1, wherein the predefined criteria associated comprises a second handle for the social media platform, and the online social media comprises text content.

4. The method of claim 1, the predefined criteria comprises a location, and wherein the online social media content comprises location metadata.

5. The method of claim 1, wherein the method comprises the step of receiving customer-defined demographic information of the customer, and wherein the step of determining the matching score is further based on comparing the predefined criteria with the customer-defined demographic information.

6. The method of claim 1, wherein the electronic display screen is part of a customer mobile computer.

7. The method of claim 1, wherein the electronic display screen is part of a kiosk.

8. A system for delivering an advertising graphic to an electronic display screen viewable by a customer, the system comprising:
a processor; and
a memory operatively connected to the processor, wherein the memory comprises a non-transitory computer readable medium storing instructions, that when executed by the processor, cause the processor to implement a method comprising the steps of:
receiving a handle of the customer for a social media platform;
determining a matching score based on comparing predefined criteria for targeting the advertising graphic with online social media content posted in association with the handle;
determining whether to target the advertising graphic to the customer based on the matching score; and
conditional on determining to target the advertising graphic to the customer, transmitting, to the electronic display screen, data for displaying the advertising graphic on the electronic display screen.

9. The system of claim 8, wherein the predefined criteria comprises a metadata hashtag or a keyword, and the online social media content comprises text content.

10. The system of claim 8, wherein the predefined criteria associated comprises a second handle for the social media platform, and the online social media comprises text content.

11. The system of claim 8, the predefined criteria comprises a location, and wherein the online social media content comprises location metadata.

12. The system of claim 8, wherein the method comprises the step of receiving customer-defined demographic information of the customer, and wherein the step of determining the matching score is further based on comparing the predefined criteria with the customer-defined demographic information.

13. The system of claim 8, comprising a kiosk and the electronic display screen attached to the kiosk.

14. The method of claim 1, the method further comprising the step of, before said determining a matching score:
analyzing a digital image of the customer to determine customer biometric information; and
wherein said determining a matching score is further based on comparing the predefined criteria for targeting the advertising graphic with both the customer biometric information and said online social media content posted in association with the handle.

15. The method of claim 14, wherein the digital image is a thermographic digital image.

16. The method of claim 15, wherein the electronic display screen is part of a kiosk, and the digital image is acquired using a digital camera attached to the kiosk.

17. The system of claim 8, further comprising:
a digital camera, wherein the processor is operatively connected to the digital camera to access digital images acquired by the digital camera; and
wherein the processor implemented method further comprises the step of, before said determining a matching score:
analyzing a digital image of the customer acquired by the digital camera to determine customer biometric information; and
wherein said determining a matching score is further based on comparing the predefined criteria for targeting the advertising graphic with both the customer biometric information and said online social media content posted in association with the handle.

18. The system of claim 16, wherein the digital image is a thermographic digital image.

19. The system of claim 17, further comprising a kiosk to which the electronic display screen and the digital camera are attached.
